(19) United States
(12) Patent Application Publication
(10) Pub. No.: US 2024/0402513 A1
(43) Pub. Date: Dec. 5, 2024

(54) AUGMENTED REALITY EYEWEAR DISPLAYS WITH INSERTABLE PRESCRIPTION LENSES

(71) Applicant: GOOGLE LLC, Mountain View, CA (US)

(72) Inventors: Charles R. Schabacker, San Jose, CA (US); Bach Nguyen, Coral Springs, FL (US); William Kinzy Jones, JR., Fort Lauderdale, FL (US); Nabila Zaman, Cambridge (CA)

(21) Appl. No.: 18/218,418

(22) Filed: Jul. 5, 2023

Related U.S. Application Data
(60) Provisional application No. 63/470,545, filed on Jun. 2, 2023.

(51) Int. Cl. G02C 5/02; G02B 27/01; G02C 7/02

(52) U.S. Cl. CPC G02C 5/02; G02B 27/0176; G02C 7/02; G02B 2027/0156; G02B 2027/0178; G02C 2200/08

(57) ABSTRACT

An augmented reality (AR) or mixed reality (MR) eyewear display includes a frame with two lens rims. One of or both of the lens rims include eye-side lens installment features to remove or insert an eye-side lens into the lens rim. The lens rim includes a lens retention ring that extends around the lens rim between two ends of the lens retention ring positioned at a first side of the lens rim. The lens retention ring is configurable in an open state to remove or insert an eye-side lens in the first lens rim, and in a closed state to fix the eye-side lens in the first lens rim, wherein the two ends are farther apart from one another in the open state than in the closed state.

### BACKGROUND

Augmented reality (AR) eyewear displays provide a user with an interactive experience that enhances the real world with images generated by the AR eyewear display. In some cases, AR eyewear displays include integrated vision correction prescription lenses (referred to as prescription lenses, or Rx lenses, for short) so a user does not have to wear a separate pair of eyeglasses or contact lenses with the AR eyewear display. In this manner, AR eyewear displays with integrated Rx lenses allow a wider range of users to enjoy an AR experience. Due to the complex nature of AR eyewear displays, conventional techniques for fulfilling different Rx lens types in AR eyewear displays typically fall on the AR eyewear display manufacturer. In some cases, it may be advantageous for parties other than the AR eyewear display manufacturer to fulfill an Rx lens or update the Rx lens in the AR eyewear display to reduce delays in delivering the AR eyewear display to the user.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example eyewear display, in accordance with some embodiments.

FIG. 2 illustrates a partially transparent view of an eyewear display, such as the eyewear display of FIG. 1, including a lens stack serving as an optical combiner, in accordance with various embodiments.

FIGS. 3A and 3B illustrate examples of an exploded view and an assembled view, respectively, of a lens rim portion of an eyewear display, such as the eyewear display of FIG. 1 or of FIG. 2, including a lens retention ring, in accordance with various embodiments.

FIG. 4 illustrates an example view of a lens rim portion of an eyewear display showing a waveguide carrier and a second lens, such as those illustrated in FIGS. 3A and 3B, in accordance with various embodiments.

FIG. 5 illustrates a cross section view of the lens rim portion of FIG. 4, in accordance with various embodiments.

FIG. 6 illustrates a close up view of the lens rim portion of FIG. 5, in accordance with various embodiments.

FIG. 7 illustrates an example exploded view of an assembly flow for removing and inserting a second lens into a lens rim of an eyewear display, such as the eyewear display of FIG. 1, in accordance with various embodiments.

FIG. 8 illustrates an assembled view of the lens portion of the eyewear display of FIG. 7, in accordance with various embodiments.

FIG. 9 illustrates an example exploded view of an eyewear display, such as one corresponding to eyewear display of FIG. 1, that includes second lens installment features on both lens rims, in accordance with various embodiments.

FIG. 10 illustrates an example cross section view of a portion of a lens rim of an eyewear display, such as one corresponding to FIG. 1, with the eye side lens fixed into the lens rim by a lens retention ring, in accordance with various embodiments.

FIG. 11 illustrates two diagrams showing examples of the lens retention ring in the open state and the closed state around a second lens, in accordance with various embodiments.

FIG. 12 illustrates two diagrams showing examples of the lens retention ring with an integrated elastic link in the open state and the closed state around a second lens, in accordance with various embodiments.

FIG. 13 illustrates an example of a semi-exploded view of a lens rim portion of an eyewear display, such as eyewear display of FIG. 1, with a lens retention ring enveloped by a silicone overmold, in accordance with various embodiments.

FIG. 14 illustrates a close up and assembled cross section view of the bottom of the lens rim portion shown in FIG. 13.

FIG. 15 illustrates an example of a detachable rim piece, in accordance with various embodiments.

FIG. 16 illustrates an example second lens (e.g., an Rx eye side lens) installment process, in accordance with various embodiments.

### DETAILED DESCRIPTION

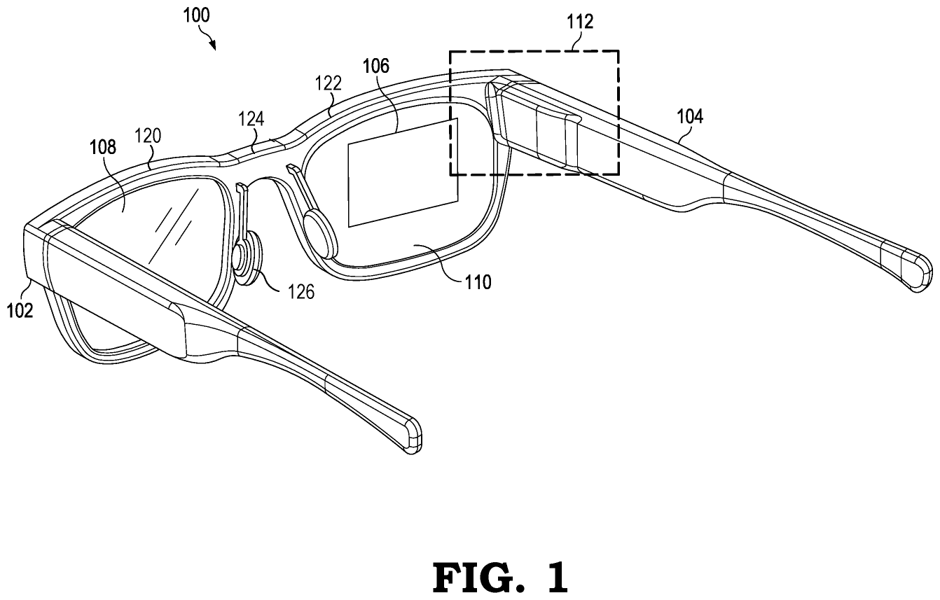

In some cases, AR eyewear displays (referred to as eyewear displays for short) include Rx lenses with curvatures corresponding to a user's vision correction prescription. For example, if a user is near-sighted, the eyewear display includes negative Rx lenses to enable a user to see distant objects more clearly. Similarly, if a user is far-sighted, the eyewear display includes positive Rx lenses to enable a user to see nearby objects more clearly. Conventionally, the burden of fulfilling this wide range of Rx lens types falls on the eyewear display manufacturer due to the complex design considerations of eyewear displays. Examples of the eyewear display design considerations include maintaining ingress protection (IP) sealing, preserving optical alignment, protecting fragile components, and ensuring that the Rx lens stays in place during drop or high-acceleration events. Furthermore, it is typically desirable for the features that retain the Rx lens and provide the sealing between lens interfaces to be as discreet as possible to minimize the aesthetic impact and bulk added to the eyewear display. In some cases, it may be advantageous to design an eyewear display to enable other parties (e.g., an optometrist) to insert an Rx lens. FIGS. 1-16 illustrate techniques that enable a party other than the eyewear display manufacturer to fulfill a user's Rx lens type in the eyewear display. Thus, the burden to fulfill a wide range of Rx lens types in an eyewear display is shifted away from the eyewear display manufacturer, thereby allowing users requiring Rx lenses to enjoy the AR experience with reduced or minimal Rx lens manufacturing delays.

To illustrate, in some embodiments, an eyewear display includes a frame with two lens rims. At least a first lens rim of the two lens rims is configured to hold a lens serving as an optical combiner that allows ambient light to pass through while also propagating display light generated by the eyewear display to a user of the eyewear display. The lens includes a lens stack with a first lens (e.g., a world-side lens) and a waveguide arranged adjacent to the world-side lens. In some embodiments, the lens stack also includes a placeholder lens on an eye-side of the waveguide. That is, the waveguide is positioned between the first lens and the placeholder lens. In some cases, the placeholder lens is initially a “blank” (i.e., does not include a vision correction prescription) lens. The first lens rim includes a lens retention ring. The lens retention ring includes two ends positioned in a cavity on a first side of the first lens rim, and the lens retention ring extends around the first lens rim between the two ends. The eyewear display also includes a detachable rim piece at the first side of the first lens rim, the detachable rim piece covering the cavity in which the two ends are positioned. In some embodiments, the lens retention ring is configurable in two states. That is, the lens retention ring can be placed in either a first state or in a second state and switch between both states. For example, the lens retention ring is initially placed in a first state (e.g., a closed state) with its two ends closer to one another compared to when the lens retention ring is in a second state (e.g., an open state). In the closed state, the lens retention ring is constricted so as to lock a lens into place in the first lens rim. When switched to the open state, the lens retention ring is relaxed so as to allow for a lens to be removed or inserted into the first lens rim. In some embodiments, the lens retention ring is initially held in the closed state by a locking clip that forces the two ends of the lens retention ring closer together. Removing the locking clip causes the two ends to move farther apart and transition the lens retention ring to the open state. This allows for the placeholder lens to be removed from the first lens rim and for a second lens (e.g., an Rx lens fulfilled by an optometrist) to be inserted into the void left by the removal of the placeholder lens. Then, re-inserting the locking clip back into its initial position in the cavity forces the two ends of the lens retention ring closer together to transition the lens retention ring back to the closed state, thus constricting the lens retention ring to lock the second lens within the first lens rim. Afterwards, the detachable rim piece is re-attached over the cavity to complete the process. In this manner, a party other than the eyewear display manufacturer is able to insert an Rx lens into the eyewear display. This reduces the burden of fulfilling all Rx lens types on the eyewear display manufacturer, thus enabling more users requiring Rx lenses to enjoy the AR experience.

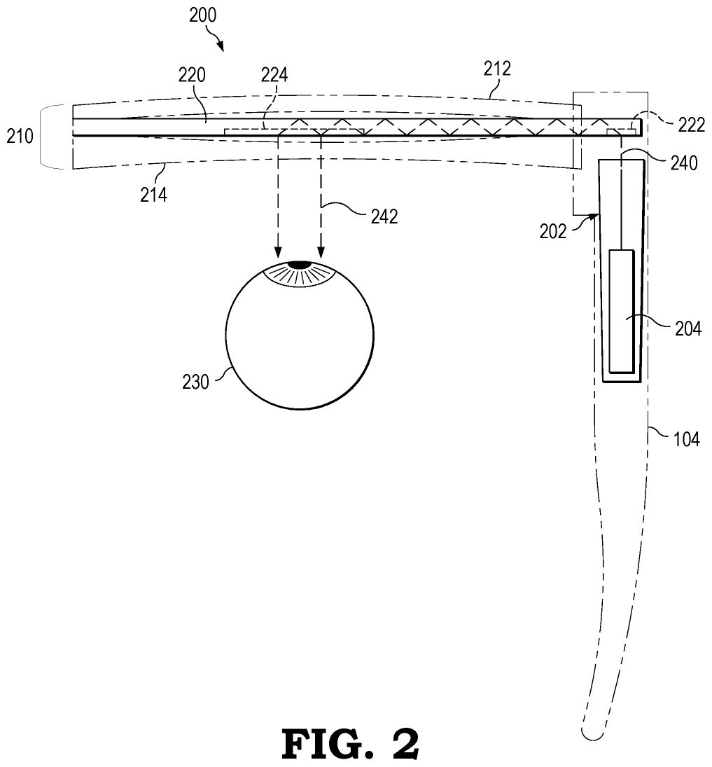

FIG. 1 illustrates an example eyewear display 100 in accordance with various embodiments. The eyewear display 100 (also referred to as a wearable heads up display (WHUD), head-mounted display (HMD), near-eye display, or the like) has a support structure, or frame, 102 that includes an arm 104 which houses a micro-display projection system configured to project images toward the eye of a user such that the user perceives the projected images as being displayed in a field of view (FOV) area 106 of a display at one or both of lens elements 108, 110 (only the FOV area 106 for lens element 110 is shown and labeled for clarity purposes). In the depicted embodiment, the frame 102 of the eyewear display 100 is configured to be worn on the head of a user and has a general shape and appearance (i.e., “form factor”) of an eyeglasses frame. The frame 102 contains or otherwise includes various components to facilitate the projection of such images toward the eye of the user, such as an image source (also referred to as light engine, optical engine, projector, or the like) and a waveguide (shown in FIG. 2, for example). In some embodiments, the frame 102 further includes various sensors, such as one or more front-facing cameras, rear-facing cameras, other light sensors, motion sensors, accelerometers, and the like. The frame 102 further can include one or more radio frequency (RF) interfaces or other wireless interfaces, such as a Bluetooth™ interface, a WiFi interface, and the like. The frame 102, in some embodiments, further includes processing circuitry or control circuitry to carry out functions of the eyewear display 100 such as eye tracking functions, for example. Further, in some embodiments, the frame 102 includes one or more batteries or other portable power sources for supplying power to the electrical components of the eyewear display 100. In some embodiments, some or all of these components of the eyewear display 100 are fully or partially contained within an inner volume of frame 102, such as within the arm 104 in a temple region 112 of the frame 102 or in a nose bridge 124 of the frame 102. It should be noted that while an example form factor is depicted, it will be appreciated that in other embodiments the eyewear display 100 may have a different shape and appearance from the eyeglasses frame depicted in FIG. 1.

As illustrated in FIG. 1, the eyewear display 100 includes two lens rims 120, 122 with a nose bridge 124 therebetween. In some embodiments, each lens rim includes a nose piece 126 (only one labeled for clarity purposes) that rests on the nose of a user when wearing the eyewear display 100. For example, lens rim 120 includes nose piece 126 and lens rim 122 also includes a corresponding nose piece (not labeled for clarity purposes). In some embodiments, the nose piece 126 is detachable from the lens rim 120 to expose a cavity, such as a loading cavity housing the two ends of a lens retention ring and, in some embodiments, a locking clip, to enable for the insertion or replacement of an eye-side lens (e.g., an Rx lens) of the lens element 108, 110.

One or both of the lens elements 108, 110 are used by the eyewear display 100 to provide an AR or mixed reality (MR) display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, one or more scan mirrors, one or more optical relays, and/or one or more prisms. In some embodiments, multiple image sources are included in the frame 102. In some cases, the multiple image sources are located in the temple region 112, in the nose bridge 124, or in a combination of the two (e.g., one image source in the temple region 112 and another image source in the nose bridge 124). One or both of the lens elements 108, 110 thus includes at least a portion of a waveguide that routes display light received by the multiple incouplers of the waveguide to the respective multiple outcouplers of the waveguide, which output the display light toward an eye of a user of the eyewear display 100. The display light is modulated and projected onto the eye of the user such that the user perceives the display light as an image in the FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, each of the lens elements 108, 110 includes a lens stack including a first lens and a second lens with the waveguide disposed therebetween. For example, in some embodiments, the first lens is a world-side lens (e.g., facing away from the user) and the second lens is an eye-side lens (e.g., facing toward the user). In some embodiments, the second lens is a vision correction prescription lens (or Rx lens) that accommodates the user's vision prescription. In some embodiments, the eyewear display 100 is designed to allow parties other than the manufacturer of the eyewear display 100 to remove and/or insert a second lens in the eyewear display. This allows for parties other than the eyewear display manufacturer to fulfill different Rx lens types for the eyewear display 100. For example, each lens rim 120, 122 of the eyewear display 100 includes a detachable nose piece (e.g., nose piece 126 on lens rim 120) that allows a third party access to replace or insert a second lens (i.e., an eye-side lens) into the eyewear display 100 by manipulating a lens retention ring in the lens rim 120, 122 to switch between an open state (to remove and/or insert the second lens) and a closed state (to lock the second lens in place).

In some embodiments, each of the one or more image sources in the eyewear display 100 is a matrix-based projector, a scanning laser projector, or any combination of a modulative light source such as a laser or one or more LEDs and a dynamic reflector mechanism such as one or more dynamic scanners or digital light processors. In some embodiments, the image source includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The image source is communicatively coupled to a controller and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to a processor (not shown) that generates content to be displayed at the eyewear display 100. The image source scans light over a variable area, designated the FOV area 106, of the eyewear display 100. The scan area size corresponds to the size of the FOV area 106, and the scan area location corresponds to a region of one of the lens elements 108, 110 at which the FOV area 106 is visible to the user. Generally, it is desirable for a display to have a wide FOV area to accommodate the outcoupling of light across a wide range of angles. Herein, the range of different user eye positions that will be able to see the display is referred to as the eyebox of the eyewear display 100.

FIG. 2 illustrates a portion of an eyewear display 200 in accordance with various embodiments. The eyewear display 200, for example, corresponds to the eyewear display 100 of FIG. 1.

As shown in FIG. 2, the eyewear display 200 includes an image projection system 202 with an image source 204 (also referred to as light engine, optical engine, projector, or the like). In some embodiments, the image projection system 202, including the image source 204, is included in the arm 104 of the eyewear display 200. The image projection system 202 emits display light 240 toward the incoupler 222 of a waveguide 220 that is integrated into lens 210.

The eyewear display 200 includes a lens 210 that serves as an optical combiner. In some embodiments, the lens 210 corresponds to one of lens elements 108, 110 of FIG. 1. In some embodiments, the lens 210 is held in one of the two lens rims (such as lens rim 120 or 122 of FIG. 1) of the eyewear display 200. The lens 210 includes a lens stack (or stack for short) including a first lens 212, a second lens 214, and a waveguide 220 disposed between the first lens 212 and the second lens 214. As illustrated, the first lens 212 is a world-side lens and the second lens 214 is an eye-side lens. In some embodiments, the waveguide 220 includes an incoupler 222 to incouple display light 240 into the waveguide 220 such that the display light is propagated within the waveguide 220 via various instances of total internal reflection (TIR). The waveguide 220 also includes an outcoupler 224 to outcouple the display light 242 toward an eye 230 of the user. Thus, the eyewear display 200 includes a lens 210 serving as an optical combiner that is held in place by a corresponding lens rim (e.g., such as one of lens rims 120, 122 of FIG. 1) of the eyewear display 200. Light exiting through the outcoupler 224 travels through the second lens 214. In use, the light exiting second lens 214 enters the pupil of an eye 230 of a user wearing the eyewear display 200, causing the user to perceive a displayed image carried by the light output by the image source 204. For example, the user perceives the displayed image over an FOV area such as FOV area 106 of FIG. 1. The different layers of the lens 210 are substantially transparent, such that light from real-world scenes corresponding to the environment around the eyewear display 200 passes through the first lens 212, the second lens 214, and the waveguide 220 to the eye 230 of the user. In this way, images or other graphical content output by the image projection system 202 are combined (e.g., overlayed) with real-world images of the user's environment when projected onto the eye 230 of the user to provide an AR experience to the user. Although not shown in the depicted example, in some embodiments additional optical elements are included in any of the optical paths between the image source 204 and the incoupler 214, in between the incoupler 214 and the outcoupler 216, and/or in between the outcoupler 216 and the eye 220 of the user (e.g., in order to shape the laser light for viewing by the eye 230 of the user).

In some embodiments, the second lens 214 is either a placeholder lens or an Rx lens that can be removed or inserted to the eyewear display 200 by parties or entities other than the manufacturer of eyewear display 200. For example, the eyewear display 200 includes second lens installment features that allow these other parties or entities (e.g., an optometrist) to install or replace the second lens 214 of the eyewear display 200. In some embodiments, the second lens installment features include a detachable rim piece (e.g., a detachable nose piece) and a lens retention ring as described herein.

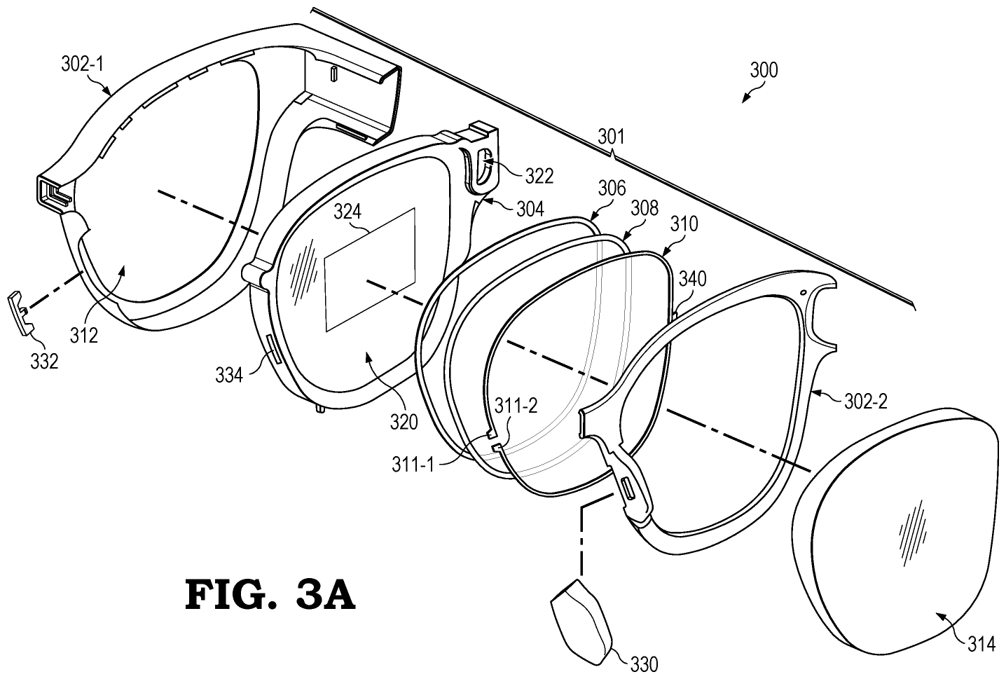

FIGS. 3A and 3B illustrate an example of an exploded view 300 and an example of an assembled view 350, respectively, of a lens rim portion of an eyewear display, such as eyewear display 100 of FIG. 1 or eyewear display 200 of FIG. 2, in accordance with various embodiments.

In exploded view 300, the eyewear display components in region 301 are those that are assembled at an eyewear display manufacturer's facility and components outside region 301 (i.e., the second lens 314) are components that can be changed or swapped by another party (e.g., an optometrist). As illustrated, the frame of the eyewear display (e.g., corresponding to frame 102 in FIG. 1) includes a front frame component 302-1 and a rear frame component 302-2. In some embodiments, the front frame component 302-1 and the rear frame component 302-2 are made of a molded plastic, a metal, an alloy, a carbon fiber material, a fiberglass material, a composite material, or any combination thereof. When joined together, the front frame component 302-1 and the rear frame component 302-2 form a cavity at a first side of the lens rim. In the embodiment shown in FIG. 3A, the cavity is formed at a nose piece side of the lens rim over which the detachable rim piece 330 is attached. The detachable rim piece 330, in some embodiments, includes a small hole (not shown) in which a tool (e.g., a pin or other needle-pointed object) can be inserted to detach the detachable rim piece 330 from the lens rim.

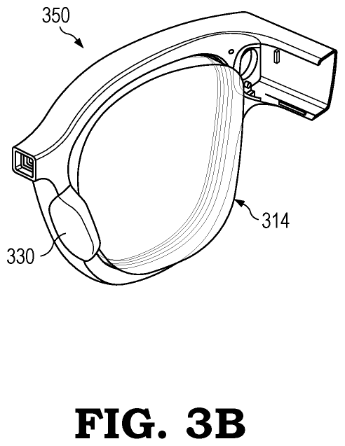

When the eyewear display is assembled (as shown in assembled view 350), the front frame component 302-1 and the rear frame component 302-2 are attached to one another and include a number of other components integrated or enclosed therein. A first lens 312 (i.e., a world-side lens) is integrated into the front frame component 302-1 or is positioned between the front frame component 302-1 and a waveguide carrier 304. In some embodiments, the first lens 312 corresponds to first lens 212 of FIG. 2. The eyewear display also includes the waveguide carrier 304 adjacent to the front frame component 302-1. The waveguide carrier is any suitable carrier material (e.g., a molded plastic) to provide a solid support structure for the waveguide 320. The waveguide 320, such as one corresponding to waveguide 220 of FIG. 2, is integrated into the waveguide carrier 304 or is positioned on the waveguide carrier 304. The waveguide 320 includes an incoupler 322, such as one corresponding to incoupler 222 of FIG. 2, and an outcoupler 324, such as one corresponding to outcoupler 224 of FIG. 2. The waveguide carrier 304 also includes one or more holes 334 that are configured to receive the locking clip 332. An adhesive 306 is placed on the waveguide carrier 304 to adhere a sealing ring 308 thereon. In some embodiments, the adhesive 306 is a glue or pressure sensitive adhesive. In some embodiments, the sealing ring 308 is a foam sealing ring, a silicone sealing ring, or the like, and provides ingress protection (IP) sealing once the second lens 314 is inserted into the lens rim of the eyewear display. A lens retention ring 310 is positioned next to the sealing ring. The lens retention ring includes two ends 311-1, 311-2 and extends around the perimeter of the lens rim. The two ends 311-1, 311-2 are positioned at a first side of the lens rim. In the illustrated embodiment, the first side corresponds to a nose piece region of the lens rim of the eyewear display. In some embodiments, the lens retention ring 310 includes a small protrusion with an opening 340 on a side opposite to the two ends 311-1, 311-2. In some embodiments, the protrusion with opening 340 is used to align the retention ring 310 with the waveguide carrier 304 and provides a flexure point for the lens retention ring 310 (shown in FIG. 4). In some embodiments, the lens retention ring 310 is a metal, an alloy, a carbon fiber material, a fiberglass material, or other type of engineered material. For example, the lens retention ring 310 has a high yield strength to allow for transitioning between an open state and a closed state as described herein. In some embodiments, the lens retention ring 310 is made of a material with a Young's modulus in the range of about 150 Gigapascals (GPa) to 250 GPa. In some embodiments, the lens retention ring 310 includes a material thickness of 0.1 to 1.0 mm. In some embodiments, the two ends 311-1, 311-2 are spaced between about 1 mm to 4 mm farther apart in the open state than in the closed state. For example, in the closed state when the locking clip 332 is attached, the two ends 311-1, 311-2 are about 2 mm closer to one another than in an open state when the locking clip 332 is removed.

The locking clip 332 is insertable and removable from the eyewear display. In some embodiments, the locking clip 332 is made of a metal, an alloy, a molded plastic, a fiberglass material, a composite material, or the like. When inserted into position in a cavity under the detachable rim piece 330 of the eyewear display, the locking clip 332 is configured to press the two ends 311-1, 311-2 of the lens retention ring 310 together, thus forcing the lens retention ring 310 to close upon a lens (e.g., second lens 314) and locking the lens into the rim of the eyewear display. That is, when finally assembled, the frame with the front frame component 302-1 and the rear frame component 302-2 includes the cavity along the lens rim that is covered by the detachable rim piece 330 (e.g., as shown in FIG. 3A, a detachable nose piece). In the embodiment shown in FIG. 3A, the locking clip 332 includes two angular notches, each notch to receive an end 311-1, 311-2 of the lens retention ring, and a protrusion for inserting the locking clip 332 into the one or more holes 334. In other embodiments, the locking clip 332 has a different form or shape to attach the locking clip 332 to the one or more holes 334 and to cause the two ends 311-1, 311-2 of the lens retention ring 310 to transition into the closed state upon being inserted into the one or more holes 334.

Upon being detached from the lens rim, the detachable rim piece 330 exposes the cavity housing the locking clip 332 fixed on the two ends 311-1, 311-2 of the lens retention ring 310. When the locking clip 332 is removed (e.g., by pulling it out via an extraction tool or by hand), the two ends 311-1, 311-2 of the lens retention ring 310 transition from it closed state to an open state (i.e., the two ends 311-1, 311-2 expand farther apart), thus relaxing the lens retention ring 310 and allowing for the removal or insertion of a second lens 314 into the lens rim of the eyewear display. Then, after inserting the second lens 314 into the lens rim, the locking clip 332 is re-inserted into the one or more holes 334 in the cavity to lock the two ends 311-1, 311-2 of the lens retention ring together to fix the second lens 314 into the lens rim. Thereafter, the detachable rim piece 330 is reattached to the lens rim (e.g., via a locking collar on the inside of the detachable rim piece 330 that engages with a corresponding channel on the rear frame portion 302-2), and the lens rim portion of the eyewear display appears as it does in assembled view 350 with the second lens 314 locked into it. As such, the eyewear display includes second lens installment features that include the locking clip 332, the detachable rim piece 330, and the lens retention ring 310 to enable a third party to insert or replace the second lens 314 in the eyewear display.

In some embodiments, the second lens 314 is manufactured according to standard Rx lens manufacturing procedures. For example, the second lens 314 includes a groove around its outer perimeter that coincides with the lens retention ring 310. That is, once the second lens 314 is inserted into the lens rim and the lens retention ring 310 is forced into the closed state, the lens retention ring 310 tightens into the groove around the outer perimeter of the second lens to lock the second lens 314 into the lens rim.

FIG. 4 illustrates an example view of a lens rim portion of an eyewear display showing the waveguide carrier 304 and the second lens 314, in accordance with various embodiments. In the view shown in FIG. 4, the second lens 314 is arranged on top of the waveguide 320 in the waveguide carrier 304 (the majority of the waveguide 320 is not shown, with the exception of the incoupler 322, due to it being covered by the second lens 314). Also, the frame components 302-1, 302-2 and the lens retention ring 310 shown in FIG. 3A are not shown in FIG. 4 for clarity purposes and for highlighting features with respect to the waveguide carrier 304 and the second lens 314.

In some embodiments, the waveguide carrier 304 includes a waveguide carrier pin 440 to provide alignment and/or a flexure point for the lens retention ring. For example, referring to FIG. 3A, in embodiments where the lens retention ring 310 includes the small protrusion with an opening 340 on the opposite side to the two ends 311-1, 311-2, the small opening 340 is positioned to align with and receive the waveguide carrier pin 440 therein. Regions 402 are lens retention ring engagement points that provide lens retention and kinematic locating features to align the second lens 314 to the lens rim in the eyewear display, and thus align the second lens 314 with the AR system of the eyewear display. For example, in some embodiments, the lens retention ring includes tabs positioned at the regions 402 that engage with a groove around the outer perimeter of the second lens 314 when the two ends of the lens retention ring are in the closed state.

The locking clip 332 is also shown in FIG. 4. The locking clip 332 includes two angular notches 432-1, 432-2 and a protrusion 434. When the protrusion 434 of the locking clip 332 is inserted into the one or more holes 334 of the waveguide carrier 304, each of the two notches 432-1, 432-2 receives an end of the lens retention ring (e.g., ends 311-1, 311-2 of lens retention ring 310 of FIG. 3A) and forces the nominally open lens retention ring to close around the second lens 314 by forcing the two ends closer together. Thus, in some embodiments, the locking clip 332 and the lens retention ring act as an attachment mechanism to anchor the second lens 314 to the waveguide carrier 304 within the lens rim. Although not shown in FIG. 4, the lens retention ring is situated in the gap 410 between the waveguide carrier 304 and the second lens 314. The locking clip 332 is disengaged from the waveguide carrier 304 with a tool that allows parties other than the eyewear display manufacturer (e.g., an optometrist) to release or insert a second lens into the lens rim. For example, the tool is a needle nose pliers, a tweezer, a screwdriver, or the like.

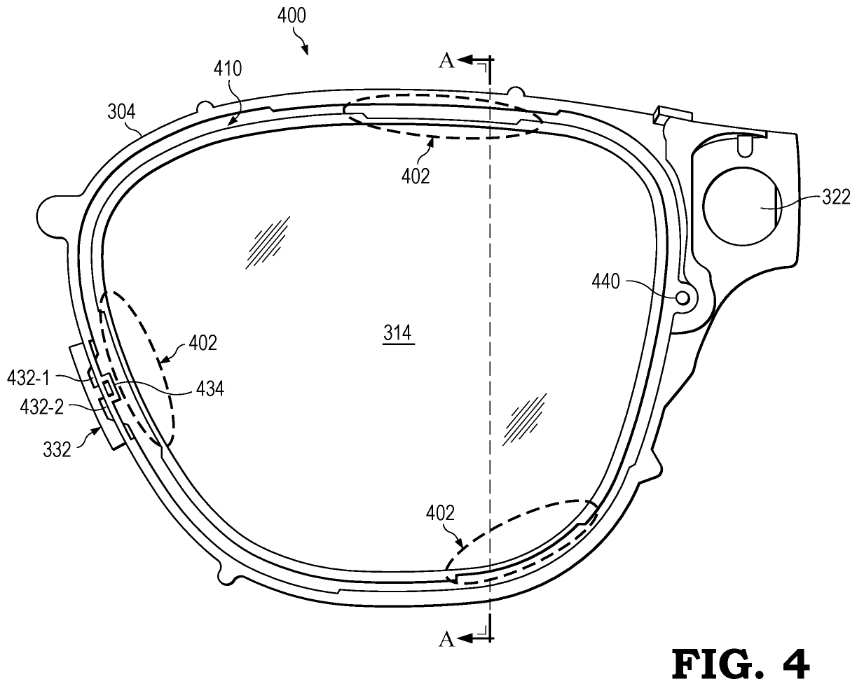

FIG. 5 is a cross-section view taken along line A-A of FIG. 4. In FIG. 5, the second lens 314 (e.g., an Rx lens with a curvature corresponding to a user's vision prescription) is fixed into the waveguide carrier 304 adjacent to and on the eye-side of the waveguide 320. Although not shown in FIG. 5, a lens retention ring (such as lens retention ring 310 of FIG. 3A) is positioned on the waveguide carrier. In the open state, the lens retention ring allows for the insertion of the second lens 314 in the lens rim. In the closed state (e.g., when the two ends 311-1, 311-2 of lens retention ring 310 of FIG. 3A), the lens retention ring engages a groove around the perimeter of the second lens 314 to lock the second lens 314 to the waveguide carrier 304 within the lens rim.

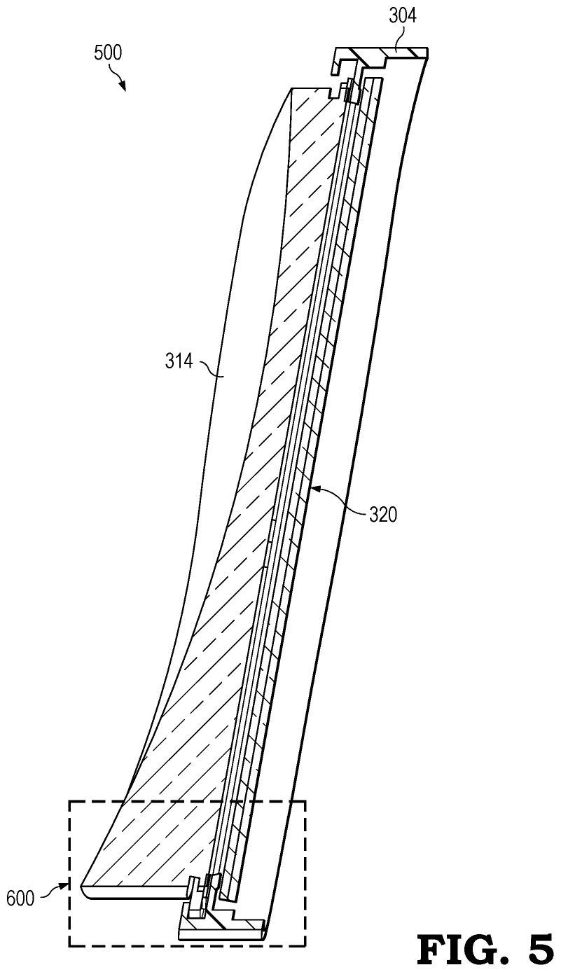

FIG. 6 shows a close-up view 600 taken from FIG. 5 in which the groove 614 around the perimeter of the second lens 314 is more clearly visible. In the closed state, the lens retention ring is constricted so as to engage into the groove 614 of the second lens 314. In some embodiments, the groove has a depth of about 0.1 mm to 1.0 mm, a width of about 0.1 mm to 1.0 mm, and is offset about 0.25 mm to about 1.5 mm from the world-side surface of the second lens 314. The lens retention ring (not shown in FIG. 6) is positioned in the waveguide carrier 304 within the void 624. The small span between the void 624 and the groove 614 of the second lens 314 provides retention in normal use cases as well as in drop events. FIG. 6 also shows the point of contact 634 between the second lens 314 and the sealing ring (such as sealing ring 308 of FIG. 3A) that provides IP sealing. Furthermore, the point of contact 634 delivers a positive force against the lens retention ring to ensure that all the components are properly aligned for AR optical purposes of the eyewear display.

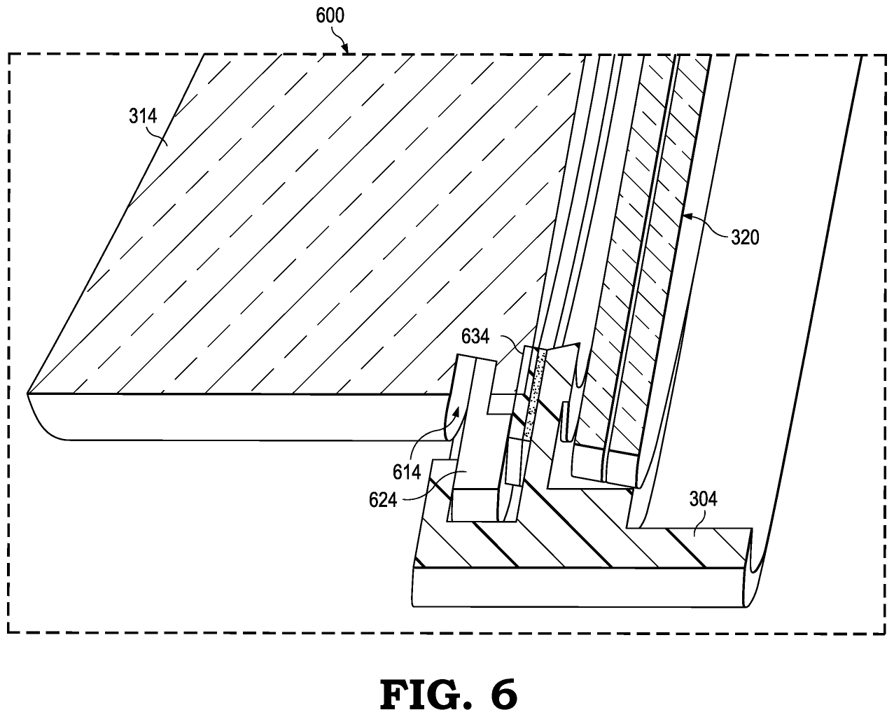

FIG. 7 shows an example exploded view of an assembly flow 700 for removing and inserting a second lens (such as second lens 314 in the previous figures) into a lens rim or lens stack (such as lens rim 120, 122 of FIG. 1, lens stack 210 of FIG. 2, lens rim portion shown in FIGS. 3-6) of an eyewear display using the second lens installment features described herein, in accordance with some embodiments.

At 702, the detachable rim piece (such as detachable rim/nose piece 330 in FIG. 3A) is removed from the lens rim 120, 122 to expose cavity 720. In some embodiments, the detachable rim piece includes a locking mechanism such as a locking collar on the inside that locks into a channel or hole of the lens rim. Accordingly, the detachable rim piece can be detached by applying pressure (e.g., via a tool or by hand) to disengage the detachable rim piece from the lens rim 120, 122. In some embodiments, the locking mechanism includes an access hole in which a pin or other narrow instrument is inserted to disengage the detachable rim piece from the lens rim 120, 122. Detaching the detachable rim piece exposes a cavity 720 in the lens rim 120, 122.

At 704, the locking clip (such as locking clip 332 of FIG. 3A) is removed from the cavity 720. In some embodiments, the locking clip is removed from a corresponding hole in the cavity 720. After removing the locking clip, the two ends 706 of the lens retention ring expand from the closed state (when the locking clip is inserted into the cavity to force the two ends together) to an open state. Thus, once in the open state, the lens retention ring (not shown, except for the two ends 706) expands around the inner perimeter of the lens rim 120, 122 such that it is disengaged from the groove around the perimeter of the second lens. Thus, at 708, the second lens (e.g., the place holder lens) can be removed from the lens rim 120, 122.

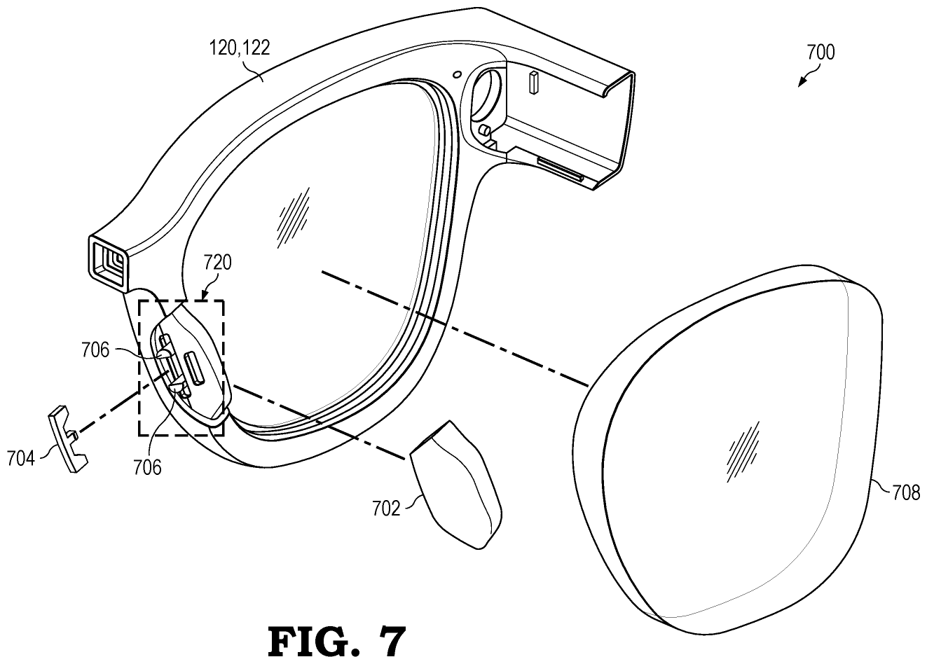

To insert a second lens (e.g., an Rx lens), the reverse order is performed. That is, the second lens is inserted into the lens rim 120, 122. Then, the locking clip is inserted into the cavity such that it forces the two ends of the lens retention ring back into the closed state, thus constricting the lens retention ring into the groove of the second lens to lock the second lens in place in the lens rim 120, 122. Lastly, the detachable rim piece is reattached to the lens rim 120, 122 to cover the cavity. FIG. 8 shows a view of the detachable nose piece 830 (such as one corresponding to detachable rim piece 330) being attached to the nose piece area 802 of a lens rim 120, 122. As illustrated in FIG. 8, the detachable nose piece 830 provides a cover so as to conceal and protect the locking clip and the ends of the lens retention ring within the cavity of the lens rim 120, 122.

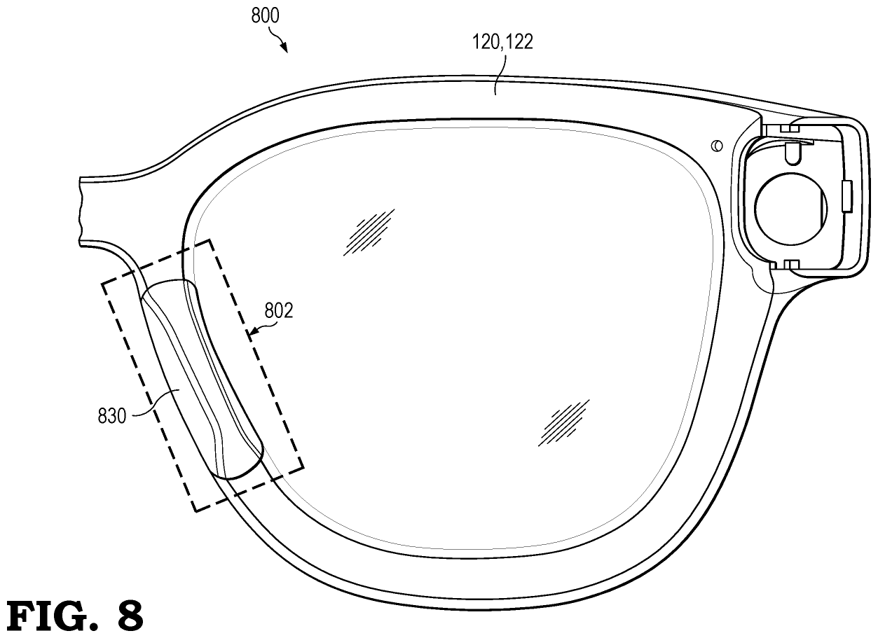

FIG. 9 illustrates an example exploded view of an eyewear display 900, such as one corresponding to eyewear display 100 of FIG. 1, that includes the second lens installment features on both lens rims 920, 922 of the frame 902, in accordance with various embodiments.

Lens rim 920 includes a nose piece 930-1 (such as one corresponding to detachable rim piece 330 of FIG. 3A) that is attachable to the lens rim 920 over cavity 932-1. Lens rim 920 includes a sealing ring 908-1 and a lens retention ring 910-1 integrated therein. The lens retention ring 910-1 includes two ends (such as those corresponding to the two ends 311-1, 311-2 of FIG. 3A) that are configured to be in an open state or in a closed state. When the locking clip 934-1 is inserted into a hole (not labeled for clarity purposes) within the cavity 932-1, the locking clip 934-1 forces the two ends of the lens retention ring 910-1 into the closed state, thereby causing the lens retention ring 910-1 to close around the second lens 914-1 and lock the second lens 912-1 into the first rim 920.

Similarly, lens rim 922 includes a nose piece 930-2 (such as one corresponding to detachable rim piece 330 of FIG. 3A) that is attachable to the lens rim 922 over cavity 932-2. Lens rim 922 includes a sealing ring 908-2 and a lens retention ring 910-2 integrated therein. The lens retention ring 910-2 includes two ends (such as those corresponding to the two ends 311-1, 311-2 of FIG. 3A) that are configured to be in an open state or in a closed state. When the locking clip 934-2 is inserted into a hole (not labeled for clarity purposes) within the cavity 932-2, the locking clip 934-2 forces the two ends of the lens retention ring 910-2 into the closed state, thereby causing the lens retention ring 910-2 to close around the second lens 914-2 and lock the second lens 912-2 into the first rim 922.

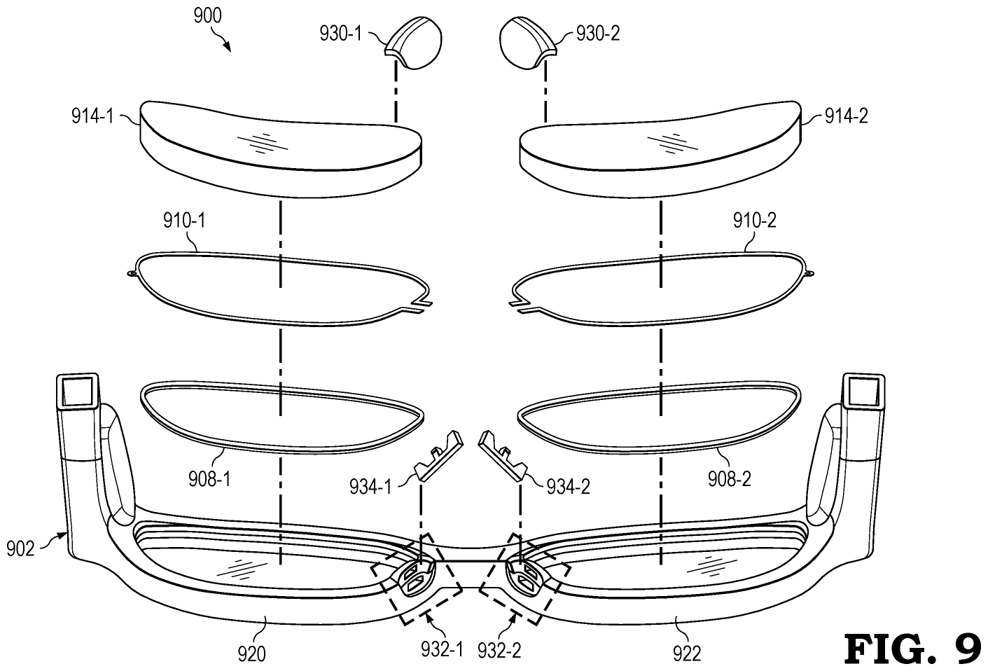

FIG. 10 is an example cross section view 1000 of a portion of a lens rim, such as one of lens rims 120, 122 of FIG. 1 or lens rims 920, 922 of FIG. 9, in accordance with various embodiments. The cross section view 1000 illustrates the second lens 1014 (such as one corresponding to second lens 314 of FIGS. 3-8 or one of second lenses 914-1, 914-2 of FIG. 9) with a groove 1030 (such as one corresponding to groove 614 in FIG. 6), a waveguide 1020 (such as one corresponding to waveguide 320 of FIG. 3A, 5, 6), and a waveguide carrier 1004 (such as one corresponding to waveguide carrier 304 of FIGS. 3-6). The cross section view 1000 also illustrates the front frame component 1002-1 (such as one corresponding to front frame component 302-1 of FIG. 3A) and the rear frame component 1002-2 (such as one corresponding to rear frame component 302-2 of FIG. 3A) as well as the lens retention ring 1010 (such as one corresponding to lens retention ring 310 in FIG. 3A or one of lens retention rings 910-1, 910-2 in FIG. 9). The cross section view 1000 further illustrates the sealing ring 1008 (such as one corresponding to sealing ring 308 in FIG. 3A or one of sealing rings 908-1, 908-2 in FIG. 9) and an adhesive 1006 (such as one corresponding to adhesive 306 in FIG. 3A).

Cross section view 1000 also illustrates dimension parameters of several of the second lens installment features as described herein. Arrow 1050 indicates the distance from the second lens 1014 world-side surface to the second lens groove 1030 and, in some embodiments, is in the range of about 0.25 mm to about 0.75 mm. Arrow 1052 indicates the distance from the front of the lens retention ring 1010 to the back of the lens retention ring 1010 and, in some embodiments, is in the range of about 0.1 mm to about 0.4 mm. Arrow 1054 indicates the distance from the waveguide carrier 1004 ledge to the waveguide carrier 1004 seat and, in some embodiments, is in the range of about 0.6 mm to about 1.2 mm.

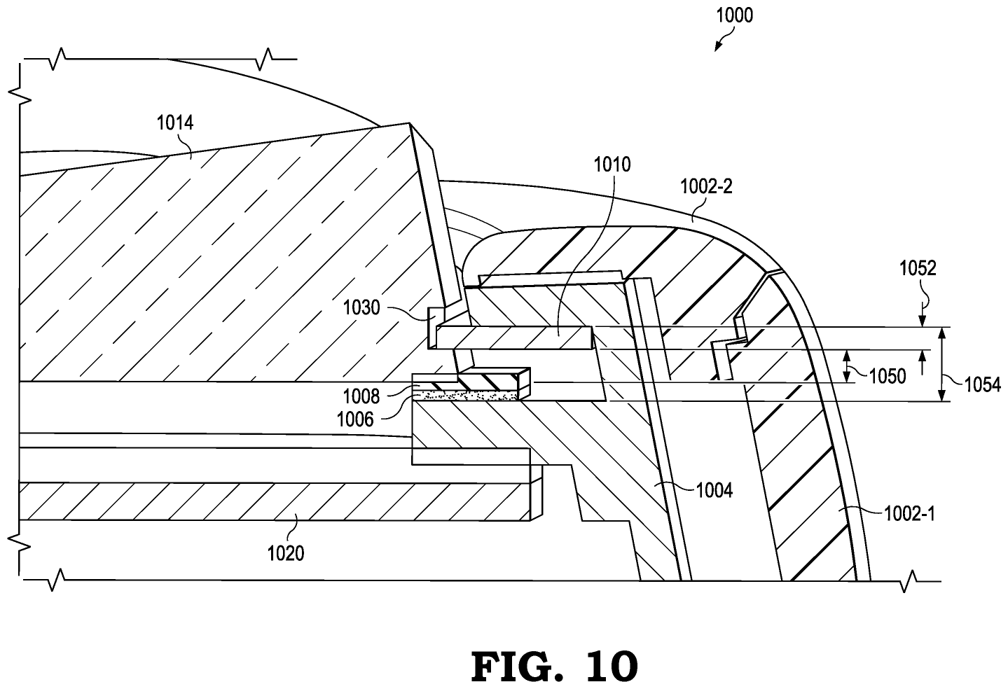

FIG. 11 illustrates two example diagrams 1100, 1150 showing examples of the lens retention ring in the open state and the closed state, respectively, around a second lens, in accordance with various embodiments. In some embodiments, the lens retention ring 1102 corresponds to the lens retention ring in any of the preceding figures, and the second lens 1104 corresponds to the second lens in any of the preceding figures. A deformation scale 1190 indicative of the amount of deformation experienced by the components depicted in FIG. 11 is also shown, with the maximum amount of deformation (MAX) at the top of the scale and the minimum amount of deformation (MIN), e.g., zero deformation, at the bottom of the scale. In some embodiments, the deformation scale 1190 ranges from MIN=0 mm to MAX=2 mm.

Diagram 1100 shows the lens retention ring 1102 in a relaxed condition, i.e., in the open state. In this open state, the two ends of the lens retention ring shown in region 1110 are spaced apart and the lens retention ring 1102 experiences a low amount of deformation (as indicated by deformation scale 1190). Thus, the lens retention ring 1102 is in an expanded state that allows the second lens 1104 to be removed and/or inserted into it. Two tabs 1108-1, 1108-2 (e.g., corresponding to regions 402 in FIG. 4) on the lens retention ring 1102 and a small protrusion with an opening 1106 on a side opposite to the two ends of the lens retention ring 1102 are also shown in diagram 1100. In some embodiments, the small protrusion with the opening 1106 corresponds to 340 of FIG. 3A and is positioned on the waveguide carrier at the waveguide carrier pin, e.g., waveguide carrier pin 440 of FIG. 4.

Diagram 1150 shows the lens retention ring in a stress-induced condition, i.e., in the closed state. In this closed state, the two ends of the lens retention ring shown in region 1160 are closer to one another than shown in region 1110 of diagram 1100. In some cases, the two ends are about 2 mm closer to one another in the closed state shown in diagram 1150 than in the open state shown in diagram 1100. Arrows 1170 indicate the forces applied to the two ends by the locking clip (not shown). Thus, the lens retention ring experiences a high amount of deformation (as indicated by deformation scale 1190) and is in a constricted state in which the lens retention ring 1102 is driven to close in around the second lens 1104, thereby locking it into place in the corresponding lens rim. For example, the tabs 1108-1, 1108-2 shown in diagram 1100 are driven into the groove around the perimeter of the second lens 1104 to lock the second lens 1104 into place along with the contact points by the two ends of the lens retention ring 1202.

As illustrated in FIG. 11, the lens retention ring is configurable in an open state (as depicted in diagram 1100) and in a closed state (as depicted in diagram 1150) according to some embodiments. The lens retention ring “is configurable” in the open state and in the closed state since the lens retention ring can be placed in either the open state or the closed state. For example, the lens retention ring transitions from the open state to the closed state based on the application of force 1170 (e.g., when the locking clip is attached to drive both ends of the lens retention ring closer together). Similarly, the lens retention ring transitions from the closed state to the open state when the force 1170 is removed (e.g., when the locking clip is removed so that both ends of the lens retention ring spring apart). That is, the lens retention ring is able to switch between the open state as illustrated in diagram 1100 and the closed state as illustrated in diagram 1150.

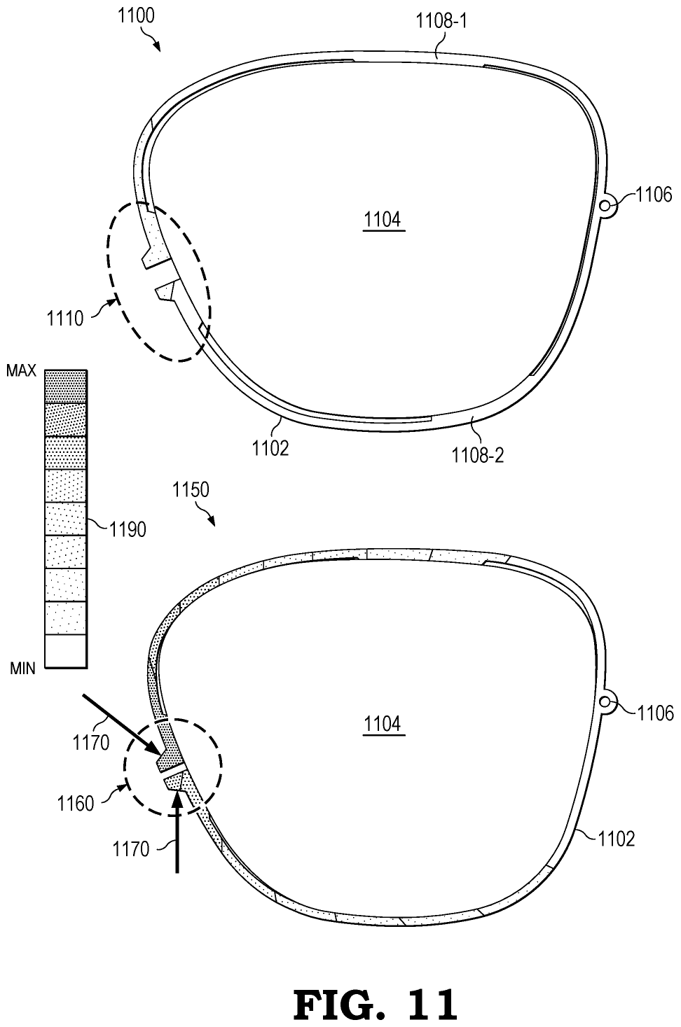

In the embodiments described in FIGS. 3-11, the second lens installment features include a locking clip that, when inserted into the cavity under the detachable rim piece along the lens rim, force the two ends of the lens retention ring into the closed state, thereby locking the second lens into the lens rim. In other embodiments, the locking clip is optional, and an elastic link is integrated between the two ends of the lens retention ring to provide the closing mechanism instead. That is, the two ends of the lens retention ring (e.g., such as ends 310-1, 310-2 of lens retention ring 310 of FIG. 3A) are joined together by an elastic link such as a metal spring, rubber or silicone band, or the like. Thus, the lens retention ring is initially in the closed state due to the elastic link being in an “unstretched” state. Upon removing the detachable rim piece, a tool is inserted between the two ends of the lens retention ring to force the two ends apart into the open state, thereby causing the elastic link to expand into a “stretched” state. The second lens is then removed and/or inserted. Upon removing the tool from between the two ends, the elastic link snaps back into the “unstretched” state, thereby causing the two ends of the lens retention ring to transition back into the closed state to lock the second lens into place in the lens rim. As such, this elastic link embodiment reduces the number of removable features (i.e., by substituting the removable locking clip with an integrated elastic link) from the eyewear display. Examples of this elastic link embodiment are shown in FIGS. 12-14.

FIG. 12 illustrates two example diagrams 1200, 1250 showing examples of the lens retention ring with an integrated elastic link in the open state and the closed state, respectively, around a second lens, in accordance with various embodiments. In some embodiments, the lens retention ring 1202 corresponds to the lens retention ring in any of the preceding figures with the addition of the elastic link 1212 integrated between the two ends of the lens retention ring, and the second lens 1104 corresponds to the second lens in any of the preceding figures. A deformation scale 1290 indicative of the amount of deformation experienced by the components depicted in FIG. 12 is also shown, with the maximum amount of deformation (MAX) at the top of the scale and the minimum amount of deformation (MIN), e.g., zero deformation, at the bottom of the scale. In some embodiments, the deformation scale 1290 ranges from MIN=0 mm to MAX=2 mm.

Diagram 1200 shows the lens retention ring 1202 in an open position when a tool (not shown) applies force 1214 to drive the two ends of the lens retention ring 1202 farther apart to stretch the elastic link 1212. In this open state, the two ends of the lens retention ring shown in region 1210 are spaced apart and the lens retention ring 1202 experiences a low amount of deformation while the elastic link 1212 experiences a high amount of deformation since it is in the “stretched” state. Thus, the lens retention ring 1202 is in an expanded state that allows the second lens 1204 to be removed and/or inserted into it. Two tabs 1208-1, 1208-2 (e.g., corresponding to regions 402 in FIG. 4) on the lens retention ring 1202 and a small protrusion with an opening 1206 on a side opposite to the two ends of the lens retention ring 1202 are also shown in diagram 1200. In some embodiments, the small protrusion with the opening 1206 corresponds to 340 of FIG. 3A and is positioned on the waveguide carrier at the waveguide carrier pin, e.g., waveguide carrier pin 440 of FIG. 4.

Diagram 1250 shows the lens retention ring in the closed state. In this state, the force 1214 shown in diagram 1200 is removed (e.g., the tool applying the force is removed from between the two ends of the lens retention ring) and the elastic link 1212 snaps back to its “unstretched” state, thereby forcing the two ends of the lens retention ring shown in region 1260 closer to one another than shown in region 1210 of diagram 1200. In some cases, the two ends of the lens retention ring are about 2 mm closer to one another in the closed state shown in diagram 1250 than in the open state shown in diagram 1200. Thus, the lens retention ring 1202 experiences a high amount of deformation (as indicated by deformation scale 1290) and is in a constricted state in which the lens retention ring 1202 is driven to close in around the second lens 1204, thereby locking it into place in the corresponding lens rim. For example, the tabs 1208-1, 1208-2 shown in diagram 1200 are driven into the groove around the perimeter of the second lens 1204 to lock the second lens 1204 into place along with the contact points by the two ends of the lens retention ring 1202.

As illustrated in FIG. 12, the lens retention ring is configurable in an open state (as depicted in diagram 1200) and in a closed state (as depicted in diagram 1250) according to some embodiments. The lens retention ring “is configurable” in the open state and in the closed state since the lens retention ring can be placed in either the open state or the closed state. For example, the lens retention ring transitions from the open state (as shown in diagram 1200) to the closed state (as shown in diagram 1250) based on the removal of force 1214 and the transition of the elastic link 1212 to the “unstretched” state. Similarly, the lens retention ring transitions from the closed state to the open state when the force 1214 is applied (e.g., when a tool is inserted between the two ends of the lens retention ring). That is, the lens retention ring is able to switch between the open state as illustrated in diagram 1200 and the closed state as illustrated in diagram 1250.

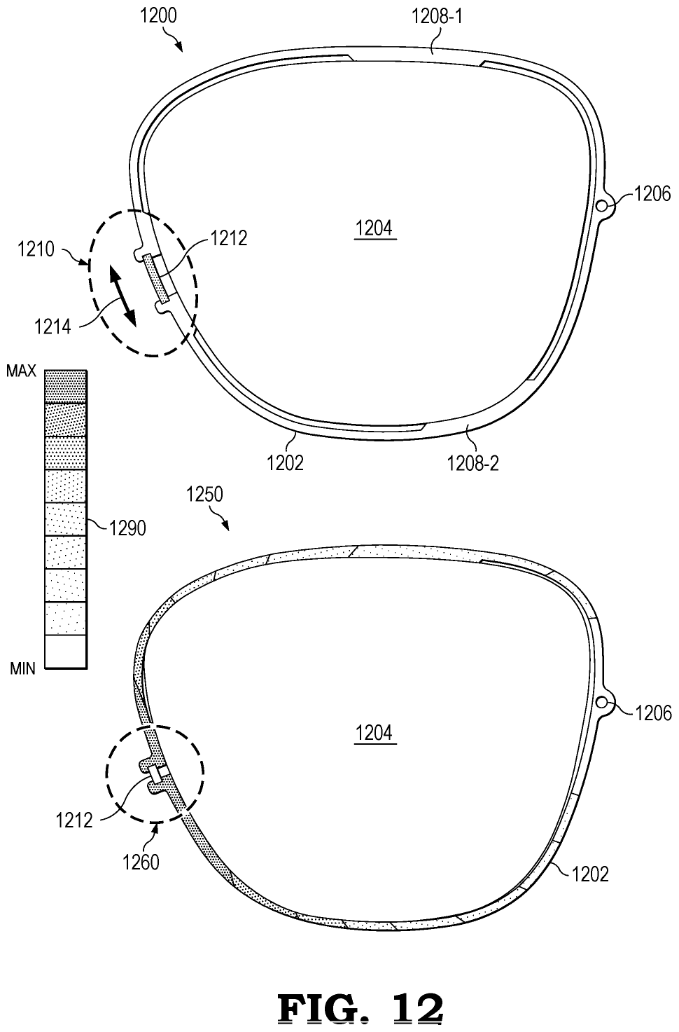

FIG. 13 illustrates an example of a semi-exploded view 1300 of a lens rim portion of an eyewear display, such as eyewear display 100 of FIG. 1 or eyewear display 200 of FIG. 2, in accordance with various embodiments. The eyewear display components in region 1301 are those that are assembled at an eyewear display manufacturer's facility and components outside region 1301 (i.e., the second lens 1314) are components that can be replaced by another party (e.g., an optometrist).

In semi-exploded view 1300, the front frame component 1302-1 and the rear frame component 1302-2 are assembled together with the waveguide carrier 1304 positioned in between. The waveguide carrier 1304 includes a waveguide 1320 integrated into it or positioned thereon. Although not shown in semi-exploded view 1300 due to being covered by the waveguide 1320, a first lens (i.e., a world-side lens) is also included in the lens rim portion on a world-side of the waveguide 1320. The lens rim portion of the eyewear display illustrated in semi-exploded view 1300 also includes an adhesive 1306 (e.g., a pressure sensitive adhesive) to attach the silicone overmold 1308 around the lens retention ring 1310 to the waveguide carrier 1304.

As shown in FIG. 13, the lens retention ring 1310 is at least partially enveloped by a silicone overmold 1308. For example, the silicon overmold 1308 at least partially envelopes the protrusion with the opening 1340 and the two ends 1311-1, 1311-2 of the lens retention ring 1310. The protrusion with the opening 1340 is positioned on a carrier pin in the waveguide carrier 1304 to provide an alignment and flexure point for the lens retention ring 1310. In some embodiments, the silicone overmold 1308 functions as an integrated sealing component (e.g., similar to sealing ring 308 of FIG. 3A) that provides IP sealing for the second lens 1314 in the lens rim portion of the eyewear display. In some embodiments, the portion of the silicone overmold 1308 between the two ends 1311-1, 1311-2 functions as an elastic link to force the two ends 1311-1, 1311-2 of the lens retention ring 1310 to close around the second lens 1314 to secure the second lens 1314 in the lens rim. That is, upon removing the detachable nose piece 1330 to expose the two ends 1311-1, 1311-2 in cavity 1350, a tool is inserted between the two ends 1311-1, 1311-2 to drive them apart (e.g., similar to the concept shown in diagram 1200 of FIG. 12) into the open state. In some embodiments, the tool is a tool such as needle nose pliers, a caliper, or the like. Then, after inserting the second lens 1314 into the lens rim and removing the tool, the silicon overmold 1308 causes the lens retention ring 1310 to contract back into the closed state, thus securing the second lens 1314 within the lens rim. As such, the locking clip 1332 is an optional feature to provide an added or redundant closing force to the two ends 1311-1, 1311-2 in addition to the elastic force applied by the silicone overmold 1308.

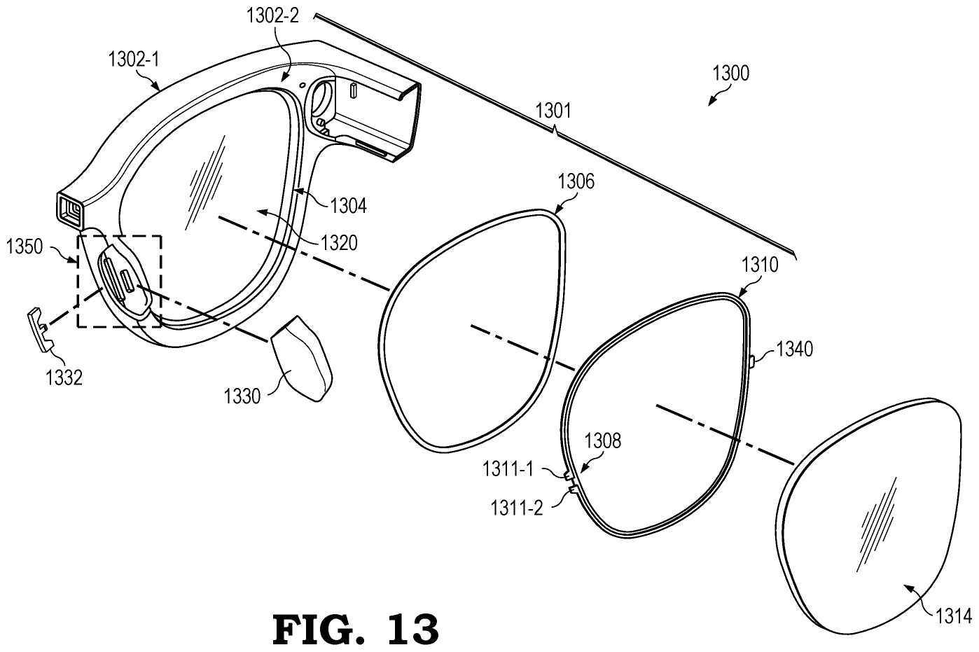

FIG. 14 is a close up and assembled cross section view 1400 of the bottom of the lens rim shown in FIG. 13. In FIG. 14, the first lens 1412 (i.e., the world-side lens) and a second carrier 1422 positioned between the waveguide 1320 and the first lens 1412 are illustrated. As illustrated in FIG. 14, the silicon overmold 1308 to the lens retention ring 1310 provides the retention and the seal in the groove around the perimeter of the second lens 1314. The lens retention ring 1310 is retained in the waveguide carrier between the silicon overmold 1308 and an undercut 1432 of the waveguide carrier.

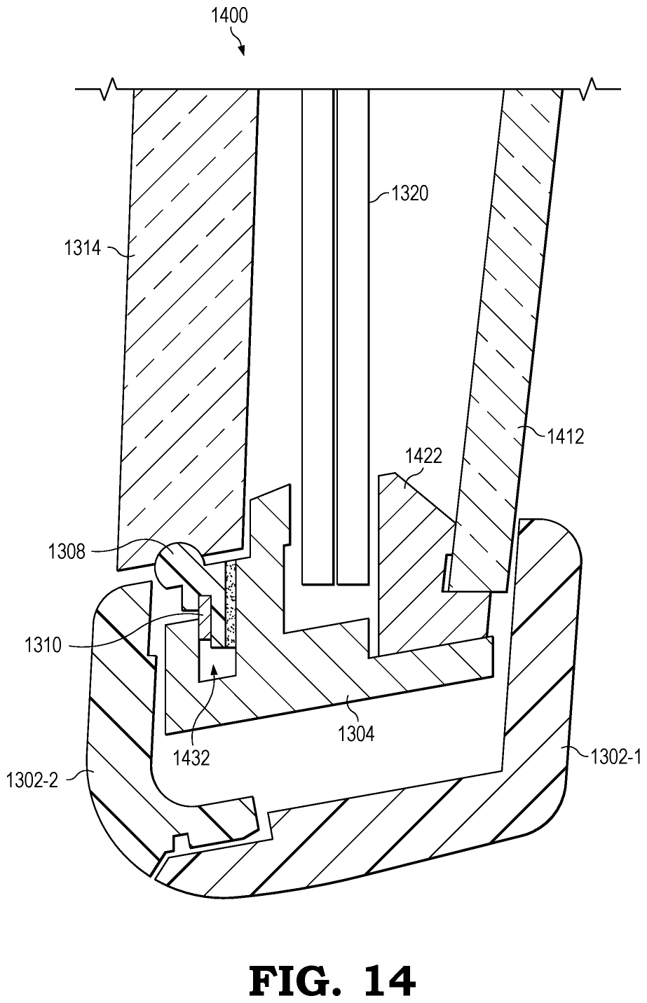

FIG. 15 illustrates an example cross section view of a detachable rim piece 1500, such as a detachable nose piece, in accordance with various embodiments.

Dashed line 1532 illustrates the outer surface of the detachable rim piece 1500 and dashed line 1534 illustrates an interior surface of the detachable rim piece. That is, the region 1536 between dashed line 1532 and dashed line 1534 includes the material that the detachable rim piece is made of (e.g., a plastic, metal, composite, or the like) and region 1538 is empty cavity within the detachable rim piece 1500. In some embodiments, as illustrated in FIG. 15, locking component 1510 is positioned at the bottom of the detachable rim piece and functions to attach the detachable rim piece 1500 to the lens rim of the eyewear display. In other embodiments, the locking component 1510 is at a different position of the detachable rim piece 1500.

In some embodiments, the detachable rim piece 1500 can optionally function as a locking clip. That is, in some embodiments, the locking clip 332 and the detachable rim piece 330 of FIG. 3A, for example, are integrated into a single component. Thus, upon being attached to the lens rim, the detachable rim piece includes a mechanism that forces the two ends of the lens retention ring to transition from the open state to the closed state. An example of such a mechanism is illustrated as prongs 1502, 1504. For example, upon being positioned at its corresponding area of the lens rim over the cavity wherein the two ends of the lens retention ring are exposed, the two ends of the lens retention ring are positioned at the ends of arrow 1510. Then, when the detachable rim piece 1500 is pressed into the lens rim to attach to the lens rim (i.e., pressed down into the lens rim), the two ends of the lens retention ring are forced closer together into the closed state indicated by the ends of arrow 1512. Thus, in this embodiment, the lock clip is integrated into the detachable rim piece 1500 as prongs 1502, 1504, thereby reducing the number of components for the second lens installment features.

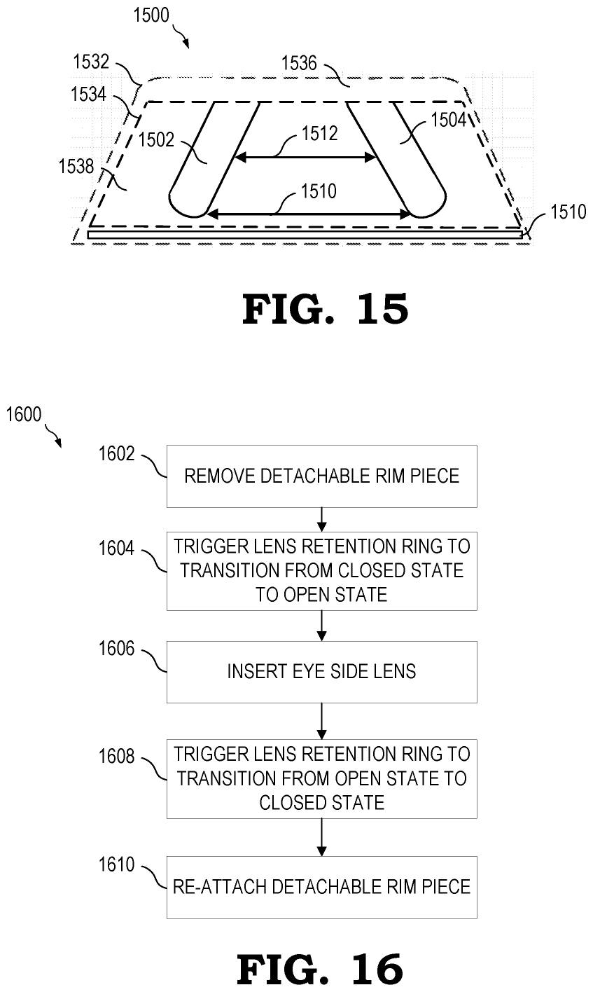

FIG. 16 illustrates an example of a flowchart 1600 describing a method to insert a second lens (e.g., such as an eye-side Rx lens) into an eyewear display, such as eyewear display 100 of FIG. 1, in accordance with various embodiments. In some embodiments, the method of flowchart 1600 is performed by a party other than the eyewear display manufacturer. In this manner, the method of flowchart 1600 enables parties other than the eyewear display manufacturer to insert an Rx lens into the eyewear display, thereby facilitating the Rx lens fulfillment process in eyewear displays that support AR or other types of MR.

At 1602, the detachable rim piece is removed from a lens rim of the eyewear display. For example, this includes removing the detachable rim piece as indicated in 702 of FIG. 7. The removal of the detachable rim piece exposes a cavity in the lens rim in which the two ends of a lens retention ring (such as a lens retention ring described in any of the preceding figures) are located.

At 1604, the lens retention ring is triggered to transition from the closed state to the open state. In some embodiments, this includes removing the locking clip 332 of FIG. 3A and as indicated at feature 704 of FIG. 7. In other embodiments implementing the detachable rim piece illustrated in FIG. 15 with the two prongs 1502, 1504, the triggering of the lens retention ring to transition from the closed state to the open state occurs when the detachable rim piece is removed, i.e., 1602 and 1604 occur concurrently with one another since the detachable rim piece also functions as the locking clip. In other embodiments implementing an elastic link integrated between the two ends of the lens retention ring, a tool is used to drive the two ends of the lens retention ring farther apart and stretch the elastic link (e.g., such as described with respect to FIG. 12).

At 1606, the eye side lens (e.g., the second lens as illustrated in any of the preceding figures) is inserted into the lens rim. In some embodiments, the eye side lens is an Rx lens.

At 1608, the lens retention ring is triggered to transition from the open state to the closed state. In some embodiments, this includes reattaching the locking clip 332 of FIG. 3A. In other embodiments implementing the elastic link integrated between the two ends of the lens retention ring, the tool used to drive the two ends of the lens retention ring farther apart is removed so that the elastic link snaps back into an unstretched position and driving the two ends of the lens retention ring closer together into the closed state (e.g., such as described with respect to FIG. 12). In other embodiments implementing the detachable rim piece illustrated in FIG. 15 with the two prongs 1502, 1504, the triggering of the lens retention ring to transition from the open state to the close state occurs when the detachable rim piece is re-attached, i.e., occurs concurrently with 1610.

At 1610, the detachable rim piece is reattached to the lens rim to cover up the cavity housing the two ends of the lens retention ring.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display comprising:
a lens retention ring in a first lens rim in a frame of the eyewear display, the lens retention ring comprising two ends positioned at a first side of the first lens rim, wherein the lens retention ring extends within the first lens rim between the two ends; and
a detachable rim piece at the first side of the first lens rim, the detachable rim piece covering a cavity in which the two ends are positioned,
wherein the lens retention ring is configurable in:
an open state to remove or insert an eye-side lens in the first lens rim, and
in a closed state to fix the eye-side lens in the first lens rim, wherein the two ends are farther apart from one another in the open state than in the closed state.

2. The eyewear display of claim 1, wherein the lens retention ring is configurable in the open state when the detachable rim piece is detached at the first side of the first lens rim, and wherein the lens retention ring is configurable in the closed state when the detachable rim piece is attached at the first side of the first lens rim.

3. The eyewear display of claim 1, wherein the lens retention ring is disposed between a waveguide carrier and a rear frame component of the frame of the eyewear display, wherein a waveguide is disposed on or integrated into the waveguide carrier.

4. The eyewear display of claim 3, further comprising a sealing ring positioned between the lens retention ring and the waveguide carrier.

5. The eyewear display of claim 3, further comprising a carrier pin in the waveguide carrier, wherein the lens retention ring comprises an opening in which the carrier pin is positioned.

6. The eyewear display of claim 1, further comprising a removable locking clip to lock the lens retention ring in the closed state when inserted into the cavity, the removeable locking clip to force the two ends of the retention ring closer together in the closed state from the open state.

7. The eyewear display of claim 6, wherein the removable locking clip comprises two notches, each notch to receive one of the two ends of the lens retention ring, wherein the removable locking clip comprises a protrusion to fit into a hole at the first side of the first lens rim.

8. The eyewear display of claim 1, wherein upon detaching the detachable rim piece, the lens retention ring is configurable in the open state by applying a separating force between the two ends of the lens retention ring.

9. The eyewear display of claim 8, wherein the lens retention ring comprises an elastic link joining the two ends of the lens retention ring, wherein the elastic link, in a relaxed state absent of the separating force, forces the two ends of the lens retention ring together in the closed state.

10. The eyewear display of claim 1, wherein the detachable rim piece is a detachable nose piece, and the first side of the first lens rim is a nose piece area of the first lens rim.

11. The eyewear display of claim 10, wherein the detachable nose piece comprises a locking mechanism to attach the detachable nose piece to the first lens rim at the noise piece area.

12. The eyewear display of claim 1, wherein the lens retention ring is partially enveloped with a silicone overmold, wherein the lens retention ring is in the closed state absent of a separating force between the two ends and is in the open state when the separating force is applied between the two ends to stretch the silicone overmold.

13. A method comprising:
removing a detachable rim piece from at least one lens rim of two lens rims of an eyewear display to expose a cavity, the at least one lens rim comprising a lens retention ring, the lens retention ring comprising two ends positioned under the detachable rim piece in the cavity;
triggering the lens retention ring to transition from a closed state to an open state, wherein the two ends are farther apart from one another in the open state than in the closed state;
inserting an eye side lens within the at least one lens rim, wherein the eye side lens comprises a curvature corresponding to a vision correction prescription;
triggering the lens retention ring to transition from the open state to the closed state to lock the eye side lens into the at least one lens rim; and
re-attaching the detachable rim piece to the at least one lens rim to cover the cavity.

14. The method of claim 13, wherein triggering the lens retention ring to transition from a closed state to an open state comprises removing a locking clip attached in the cavity.

15. The method of claim 14, wherein triggering the lens retention ring to transition from the open state to the closed state to lock the eye side lens into the at least one lens rim comprises reattaching the locking clip to the loading cavity.

16. The method of claim 13, wherein triggering the lens retention ring to transition from a closed state to an open state comprises applying a separating force between the two ends of the lens retention ring.

17. The method of claim 16, wherein triggering the lens retention ring to transition from the open state to the closed state to lock the eye side lens into the at least one lens rim comprises removing the separating force.

18. The method of claim 16, further comprising removing a placeholder lens from the at least one lens rim prior to inserting the eye side lens within the at least one lens rim, the eye side lens occupying a void left by the removal of the placeholder lens.

19. An eyewear display comprising:
a lens retention ring in a first lens rim in a frame of the eyewear display, the lens retention ring comprising two ends positioned at a first side of the first lens rim, wherein the lens retention ring extends within the first lens rim between the two ends, wherein the lens retention ring is configurable in:
an open state to remove or insert an eye-side lens in the first lens rim, and
in a closed state to fix the eye-side lens in the first lens rim, wherein the two ends are farther apart from one another in the open state than in the closed state; and
a detachable rim piece at the first side of the first lens rim, wherein upon being removed, the detachable rim piece triggers the lens retention ring to transition from the closed state to the open state.

20. The eyewear display of claim 19, wherein the detachable rim piece comprises one or more prongs, wherein upon being attached to the first side of the first lens rim, the one or more prongs apply a force to the two ends to cause the lens retention ring to be in the closed state.
